(19) United States
(12) Patent Application Publication
(10) Pub. No.: US 2026/0212272 A1
(43) Pub. Date: Jul. 23, 2026

(54) INFORMATION PROCESSING DEVICE AND SEARCHING METHOD

(71) Applicants: Fujitsu Limited, Kawasaki-shi (JP); INDIAN INSTITUTE OF SCIENCE, Bengaluru (IN)

(72) Inventors: Sho TAKEMORI, Yokohama (JP); Yuhei UMEDA, Kawasaki (JP); Aditya GOPALAN, Bengaluru (IN)

(73) Assignees: Fujitsu Limited, Kawasaki-shi (JP); INDIAN INSTITUTE OF SCIENCE, Bengaluru (IN)

(21) Appl. No.: 19/450,832

(22) Filed: Jan. 16, 2026

(30) Foreign Application Priority Data
Jan. 20, 2025 (IN) 202511004422

(51) Int. Cl. G06N 20/00

(52) U.S. Cl. CPC G06N 20/00

(57) ABSTRACT

An information processing device includes a processor configured to estimate, based on observation history data including a parameter of a machine training model that is sampled based on a probability measure on a parameter space and an observation result that is estimated in a case of setting the parameter to the machine training model, an optimum parameter and a function of the parameter that derives the observation result set an optimization problem for minimizing a false identification probability of falsely identifying, as an optimal solution, another parameter other than the optimum parameter on the parameter space based on the estimated function and the optimum parameter and search for a parameter to be an optimal solution to the machine training model by applying a projection subgradient method to the optimization problem.

### CROSS-REFERENCE TO RELATED APPLICATION

This application is based upon and claims the benefit of priority of the prior Indian Patent Application No. 202511004422, filed on Jan. 20, 2025, the entire contents of which are incorporated herein by reference.

### FIELD

The embodiments discussed herein are related to an information processing device and a searching method.

### BACKGROUND

As a technique of automatically optimizing pipelines and parameters of a machine training model, there is known Automated Machine Learning (AutoML). In AutoML, an optimal solution search problem of a black box function is solved to select an optimum model or pipeline.

The black box function is a function in which a gradient of the function is unknown and can only be obtained by observing a value for a parameter. The optimal solution search problem is to find an optimal solution with a minimum number of times of function evaluation while allowing some errors. For example, the optimal solution is a parameter of a machine training model.

For example, as a method for solving an optimal solution search problem of a black box function, there is known a best arm identification method and a black box optimization method. The black box optimization method includes a bandit method for minimizing regret, a Bayesian optimization method, and the like.

The related technologies are described, for example, in Japanese Laid-open Patent Publication No. 2023-171356.

### SUMMARY

According to an aspect of an embodiment, an information processing device includes a processor configured to estimate, based on observation history data including a parameter of a machine training model that is sampled based on a probability measure on a parameter space and an observation result that is estimated in a case of setting the parameter to the machine training model, an optimum parameter and a function of the parameter that derives the observation result set an optimization problem for minimizing a false identification probability of falsely identifying, as an optimal solution, another parameter other than the optimum parameter on the parameter space based on the estimated function and the optimum parameter and search for a parameter to be an optimal solution to the machine training model by applying a projection subgradient method to the optimization problem.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating a configuration of an information processing device according to an embodiment;

FIG. 2 is a flowchart illustrating a processing procedure of the information processing device according to the present embodiment;

FIG. 3 is a diagram illustrating an example of a false identification probability; and

FIG. 4 is a diagram illustrating an example of a hardware configuration of a computer that implements the same function as that of the information processing device according to the embodiment.

### DESCRIPTION OF EMBODIMENTS

However, with the related technologies described above, there is the problem that an optimum parameter of a machine training model is not able to be searched for.

Preferred embodiments will be explained with reference to accompanying drawings. The present invention is not limited to the embodiment.

Before describing the present embodiment, a supplementary explanation of related art is provided.

In a best arm identification method, a parameter set is finite in most cases. In the best arm identification method, in a case in which the parameter set is continuous, the parameter set can be applied by being discretized, but there is a problem in terms of a calculation amount. This is because discretized points corresponding to exponential order of dimensions are needed. In the best arm identification method, in a case of making a uniform search, a parameter used for the search is selected independent of a function value, so that search efficiency is bad.

In a black box optimization method, a search and use are balanced at the time of optimization. It is theoretically known that, when an optimal solution search problem is solved by the black box optimization method, an optimal solution can be found with a high probability instead of not guaranteeing goodness of parameters in a search period.

Subsequently, the following describes problem setting according to the present embodiment. The problem setting is as follows.

A parameter space X is defined as represented by Expression (1).

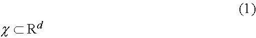

An unknown function f is defined as represented by Expression (2). Hereinafter, the unknown function f is denoted as a function f as appropriate.

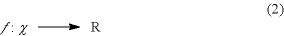

The optimum parameter is defined as represented by Expression (3). It is assumed that there is only one optimum parameter x*.

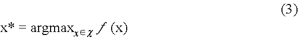

A parameter xₜ is selected for each of trials t=1, 2, 3, . . . , and yₜ is observed based on Expression (4). In Expression (4), ωₜ indicates noise of average 0. The parameter xₜ is a vector.

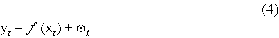

A tolerance s is assumed to be a value larger than 0 (ε>0).

The function f is assumed to be a linear model. The function f is assumed to be sampled from a Gaussian process accompanying a linear kernel. For example, a coefficient of the function f is sampled from normal distribution.

Experience distribution n_{T} of parameters that have been selected until the T-th trial is defined as represented by Expression (5). In Expression (5), Π(x) indicates the probability that x is sampled. The experience distribution Π_{T} is average sampling distribution of parameters. Herein, for z∈X, δ_{z} indicates a Dirac's delta measure satisfying x=z with a probability of 1. When a random variable X follows a probability measure δ_{z}, X=z is satisfied with a probability of 1. Thus, Expression (5) indicates experience distribution of samples x₁, . . . , x_{T}.

$${π}_{T} = \frac{1}{T} {\sum }_{t = 1}^{T} {δ}_{{x}_{t}} \qquad ( 5 )$$

For a probability measure n on the parameter space X, a covariance matrix V(Π_{T}) is defined as represented by Expression (6).

$$V ( π ) = {\sum }_{x ∈ 𝒳} π ( x ) {xx}^{T} \qquad ( 6 )$$

After T times of observation, the optimum parameter is estimated by using Expression (7). f\hat{ }_{T}(x) included in Expression (7) is defined by Expression (8). Herein, f\hat{ } means “f hat”. f\hat{ }_{T}(x) depends on how xₛ is selected, so that it is important to properly select the experience distribution Π_{T}.

$$arg {max}_{x} {\hat{f}}_{T} ( x ) \qquad ( 7 )$$

$${\hat{f}}_{T} ( x ) = {( λ + {\sum }_{s = 1}^{T} {x}_{s} {x}_{s}^{T} )}^{- 1} ( {\sum }_{s = 1}^{T} {y}_{s} {x}_{s} ) \qquad ( 8 )$$

After T times of observation, for x′ ≠x*, assuming that the probability that f(x′) is erroneously determined to be larger than f(x*)+ε is P_{T}(x′, Π_{T}), Expression (9) is approximately established.

$$\frac{1}{T} log {P}_{T} ( {x}^{′} , {π}_{T} ) ≃ - \frac{{( ϵ + f ( {x}^{*} ) - f ( {x}^{′} ) )}^{2}}{{\vert {x}^{*} - {x}^{′} \vert}_{{V ( {π}_{T} )}^{- 1}}^{2}} \qquad ( 9 )$$

Herein, for a vector x∈R^{d} and a positive definite target matrix V of Expression (10), a norm |x|V≥0 is defined by Expression (11). “The target matrix V is a positive definite” means that “all eigenvalues of V are positive”. V(Π_{T})⁻¹ indicates an inverse matrix of V(Π_{T}).

$$V ∈ {R}^{d \times d} \qquad ( 10 )$$

$$\sqrt{{x}^{T} V x} \qquad ( 11 )$$

A false identification probability of x′≠x*, which is the most difficult to be identified, is given by Expression (12).

$${sup}_{{x}^{′} \neq {x}^{⋆}} \frac{1}{T} log {P}_{T} ( {x}^{′} , {π}_{T} ) ≃ - {inf}_{{x}^{′} \neq {x}^{*}} \frac{{( ϵ + f ( {x}^{*} ) - f ( {x}^{′} ) )}^{2}}{{\vert {x}^{*} - {x}^{′} \vert}_{{V ( {π}_{T} )}^{- 1}}^{2}} \qquad ( 12 )$$

When T is sufficiently large, a purpose is to minimize the false identification probability with Π_{T}. That is, the purpose is that n_{T} becomes a solution to an optimization problem represented by Expression (13) when T is sufficiently large. Π is a probability measure on the parameter space X. In a reference literature (Jourdan, M. and Degenne, R. (2022). Choosing Answers in Epsilon-Best-Answer Identification 407 for Linear Bandits. In International Conference on Machine Learning, pages 10384-10430. 408 PMLR.), the same objective function is considered in a case in which the parameter space X is finite.

$${sup}_{π} {inf}_{{x}^{′} \neq {x}^{*}} \frac{{( ϵ + f ( {x}^{*} ) - f ( {x}^{′} ) )}^{2}}{{\vert {x}^{*} - {x}^{′} \vert}_{{V ( π )}^{- 1}}^{2}} \qquad ( 13 )$$

As described above, to minimize the false identification probability, the optimization problem of Expression (13) needs to be solved for the probability measure r on the parameter space X. Solving the optimization problem of Expression (13) can be regarded as 2 players game.

In Expression (13), inf is an abbreviation of infimum. inf means to select the optimum parameter x* and a parameter x′, which is difficult to be identified, to increase the false identification probability.

In Expression (13), sup is an abbreviation of supremum. sup means to properly select the probability distribution Π so that x* and x′ can be easily identified, no matter how the parameter x′ is difficult to be identified.

The problem setting has been described above.

Subsequently, a supplementary explanation is provided for a problem in the related art in adjusting parameters of AutoML in relation to the problem setting described above. It is assumed that x indicates a hyperparameter and the like, and f(x) indicates a score of a machine training model with respect to a parameter. A higher score means higher performance of the machine training model. After selecting the parameter x in the search period, the machine training model is operated with the selected parameter, so that it is desired to minimize a probability of selecting a suboptimum parameter.

In the related art, the parameter x is sampled so that a probability PT(f(x*)+ε≤f(x)) of false identification for all parameters x is reduced.

However, in the related art, the false identification probability becomes too small for the parameter x that can be easily identified. For example, the parameter x that can be easily identified is the parameter x with which f(x)<<f(x*) is satisfied.

Additionally, in the related art, the false identification probability becomes too large for the parameter x that is difficult to be identified. For example, the parameter x that is difficult to be identified is the parameter x with which f(x) is substantially equal to f(x*).

In the related art, a search is uniformly made without considering where the optimum parameter is present, so that there is the problem that the false identification probability for the parameter that can be easily identified becomes too low, and the false identification probability for the parameter that is difficult to be identified becomes too high. The number of samples is limited, so that the false identification probability is not able to be lowered for the parameter that can be easily identified and the parameter that is difficult to be identified, and it is desired to lower the false identification probability in a balanced manner.

Herein, the parameter x is continuous, so that, when sampling distribution is changed to lower the false identification probability of the parameter that is difficult to be identified, the false identification probability around the parameter x is also changed, and the false identification probability of other parameters may be increased.

Strictly speaking, the probability measure n on the region X is selected so that a value of Expression (14) is maximized, and it is difficult to directly solve Expression (14). In Expression (14), the function f is defined by inf, so that it is not a smooth function.

$${inf}_{{x}^{′}} \frac{{( ϵ + f ( {x}^{*} ) - f ( {x}^{′} ) )}^{2}}{{\vert {x}^{*} - {x}^{′} \vert}_{{V ( π )}^{- 1}}^{2}} \qquad ( 14 )$$

Next, the following describes an information processing device according to the present embodiment. The information processing device according to the present embodiment is referred to as an “information processing device 100”. The information processing device 100 uses a projection subgradient method on V′ for Expression (15) assuming that V′={V(Π): n is a probability measure on X.}. As the projection subgradient method, a method described in a reference literature (BUBECK, Sebastien, et al. Convex optimization: Algorithms and complexity. Foundations and Trends in Machine Learning, 2015, 8.3-4: 231-357.) may be used.

$$F ( V ) = {inf}_{{x}^{′} \neq {x}^{*}} \frac{{( ϵ + f ( {x}^{*} ) - f ( {x}^{′} ) )}^{2}}{{\vert {x}^{*} - {x}^{′} \vert}_{{V}^{- 1}}^{2}} \qquad ( 15 )$$

The information processing device 100 uses a method of causing −gₜ to be a subgradient of V=Vt of −F, and successively updating it by Expression (16). ηₜ in Expression (16) indicates a step size.

$${V}_{t + 1} = {Π}_{v} ( {V}_{t} + {η}_{t} {g}_{t} ) \qquad ( 16 )$$

Herein, there is the problem described below in application of the projection subgradient method. The projection subgradient method is an optimization method that can be applied to a function that is not smooth, but projection for V′ needs to be calculated. In the projection subgradient method, a parameter is updated with V′, so that corresponding distribution also needs to be calculated.

The information processing device 100 performs processing as follows for the problem in application of the projection subgradient method described above. To calculate projection for V′, the information processing device 100 obtains original V(Π) of V′ close to W represented by Expression (17).

$$W := {V}_{t} + {η}_{t} {g}_{t} \qquad ( 17 )$$

To obtain original V(Π) of V′ close to W represented by Expression (17), the information processing device 100 needs to obtain a convex combination of {xx^{T}: x ∈X}close to W. In a case in which W belongs to V′, a problem of obtaining a convex combination close to W is a special case of an approximate Caratheodory problem. An acute accent on “e” of Caratheodory is omitted. The same applies hereinafter.

W does not belong to V′ in general, but a method used for the approximate Caratheodory problem may be applied. Literatures related to the approximate Caratheodory problem include a reference literature “Combettes, Cyrille W., and Sebastian Pokutta. ‘Revisiting the approximate Caratheodory problem via the Frank-Wolfe algorithm.’ Mathematical Programming 197.1 (2023): 191-214”.

The information processing device 100 can solve the optimization problem on the probability measure by applying the projection subgradient method and solving the optimization problem of the parameter space X multiple times by using the method used for the approximate Caratheodory problem. The optimization problem on the probability measure is the optimization problem represented by Expression (14).

Applications of the approximate Caratheodory problem include combinatorial optimization and the like.

Next, the following describes an example of processing of the information processing device 100. For example, the information processing device 100 performs initialization processing, estimation processing, subgradient calculation processing, projection calculation processing, and sampling processing. The following describes the estimation processing, the subgradient calculation processing, the projection calculation processing, and the sampling processing performed by the information processing device 100 in order.

First, the following describes the initialization processing performed by the information processing device 100. The information processing device 100 receives an input of initial sampling distribution no. The information processing device 100 samples x₁, x₂, . . . , x_{N} as parameters at N points from the initial sampling distribution no.

The information processing device 100 observes y₁, y₂, . . . , y_{N} based on a sampling result of the parameters at N points and Expression (4) described above. The information processing device 100 also calculates a covariance matrix VN with Expression (18) where t=N.

$${V}_{N} = {\sum }_{s = 1}^{N} {x}_{s} {x}_{s}^{T} / N \qquad ( 18 )$$

The initialization processing performed by the information processing device 100 has been described above.

Subsequently, the following describes an example of the estimation processing performed by the information processing device 100. The information processing device 100 uses, as observation histories, x₁, x₂, . . . , xₜ, and y₁, y₂, . . . , yₜ. The information processing device 100 repeatedly performs the estimation processing. In a case of performing the first estimation processing, the information processing device 100 uses, as observation histories, x₁, x₂, . . . , x_{N}, and y₁, y₂, . . . , y_{N} as the parameters at N points obtained in the initialization processing. For the second and subsequent estimation processing, the information processing device 100 adds a result of the sampling processing (described later) to the observation histories to be used.

The information processing device 100 estimates a function f\hat{ }ₜ(x) based on the observation histories and Expression (19). f\hat{ } indicates f (hat). λ is a parameter larger than 0. The information processing device 100 estimates an optimum parameter x\hat{ }ₜ based on Expression (20). x\hat{ } indicates x (hat).

$${\hat{f}}_{t} ( x ) = {( λ + {\sum }_{s = 1}^{t} {x}_{s} {x}_{s}^{T} )}^{- 1} ( {\sum }_{s = 1}^{t} {y}_{s} {x}_{s} ) \qquad ( 19 )$$

$${\hat{x}}_{t} = arg {max}_{x ∈ 𝒳} {\hat{f}}_{t} ( x ) \qquad ( 20 )$$

The estimation processing performed by the information processing device 100 has been described above.

Subsequently, the following describes an example of the subgradient calculation processing performed by the information processing device 100. When a function Fₜ(V) is assumed to be a function represented by Expression (21), the information processing device 100 calculates a subgradient −gₜ of −Fₜ using Expression (22). x′ₜ in Expression (22) is defined by Expression (23). Gₜ(V; x′) in Expression (23) is defined by Expression (24).

$${F}_{t} ( V ) = {inf}_{{x}^{′} \neq {\hat{x}}_{t}} \frac{{( ϵ + {\hat{f}}_{t} ( {\hat{x}}_{t} ) - {\hat{f}}_{t} ( {x}^{′} ) )}^{2}}{{\vert {\hat{x}}_{t} - {x}^{′} \vert}_{{V}^{- 1}}^{2}} \qquad ( 21 )$$

$${g}_{t} = \frac{\partial {G}_{t} ( \cdot ; {x}_{t}^{′} )}{\partial V} {\vert}_{V = {V}_{t}} \qquad ( 22 )$$

$${x}_{t}^{′} = arg {min}_{{x}^{′}} {G}_{t} ( V ; {x}^{′} ) \qquad ( 23 )$$

$${G}_{t} ( V ; {x}^{′} ) = \frac{{( ϵ + {\hat{f}}_{t} ( {\hat{x}}_{t} ) - {\hat{f}}_{t} ( {x}^{′} ) )}^{2}}{\vert {\hat{x}}_{t} - {x}^{′} {\vert}_{{V}^{- 1}}^{2}} \qquad ( 24 )$$

In a case of solving x′ₜ represented by Expression (23), the information processing device 100 can solve it by a fractional programming method. The information processing device 100 can also solve x′ₜ represented by Expression (23) by using a Dinkelbach algorithm. For example, description about the Dinkelbach algorithm is provided in a reference literature “Shen, Kaiming, and Wei Yu. ‘Fractional programming for communication systems-Part I: Power control and beamforming.’ IEEE Transactions on Signal Processing 66.10 (2018): 2616-2630”.

The example of the subgradient calculation processing performed by the information processing device 100 has been described above.

Subsequently, the following describes an example of the projection calculation processing performed by the information processing device 100. The information processing device 100 performs approximate projection Vₜ₊₁ for V′ of Wₜ, and calculates a probability measure rn with which Vₜ₊₁=V(Πₜ₊₁) is satisfied. More specifically, the information processing device 100 calculates the probability measure nₜ₊₁ with which Vₜ₊₁=V(πₜ₊₁) is satisfied by applying a Frank-Wolfe method so that h(V) is minimized on V′. Herein, Wₜ is equal to W represented by Expression (17). h(V) is defined by Expression (25). V′ is V(Π), and Π is a probability measure on X.

$$h ( V ) = {\vert V - {W}_{t} \vert}_{F}^{2} \qquad ( 25 )$$

For example, in a case of applying the Frank-Wolfe method, the information processing device 100 performs the following processing. The information processing device 100 assumes x∈X that maximizes a value of Expression (26) to be aₙ, and calculates distribution ρₙ based on Expression (27). V\hat{~}n in Expression (26) indicates V(ρn). V\hat{~} indicates V (tilde). ρ₀ is initial distribution, and ρ₀=Πₜ is established, for example. γₙ in Expression (27) is a step size, and set in advance. An initial value of n in Expression (26) and Expression (27) is “1”.

$${x}^{T} ( W - {\tilde{V}}_{n} ) x \qquad ( 26 )$$

$${ρ}_{n} = ( 1 - {γ}_{n} ) {ρ}_{n - 1} + {γ}_{n} {δ}_{{a}_{n}} \qquad ( 27 )$$

The information processing device 100 repeatedly performs the processing described above while incrementing n for Expression (26) and Expression (27), and outputs V(ρₙ) and distribution ρₙ as a result of the projection calculation processing in a case in which a predetermined end condition is satisfied. For example, the predetermined end condition is the condition that n is equal to or larger than a predetermined number. The distribution ρₙ output as a projection calculation result is the probability measure Πₜ₊₁ with which Vₜ₊₁=V(Πₜ₊₁) is satisfied. V(ρₙ) output as the projection calculation result is approximate Vₜ₊₁ of Π_{V′} (Wt).

The example of the projection calculation processing performed by the information processing device 100 has been described above.

Subsequently, the following describes an example of the sampling processing performed by the information processing device 100. The information processing device 100 samples xₜ₊₁ from the probability measure n₁ output as the projection calculation result. The information processing device 100 observes γₜ₊₁ based on Expression (4). The information processing device 100 may also observe γₜ₊₁ using f\hat{ }ₜ estimated in the estimation processing in the latest period.

The example of the sample processing performed by the information processing device 100 has been described above.

The information processing device 100 repeatedly performs the estimation processing, the subgradient calculation processing, the projection calculation processing, and the sampling processing until the predetermined end condition is satisfied, and outputs, as a final optimum parameter, an optimum parameter that is estimated in the estimation processing at last.

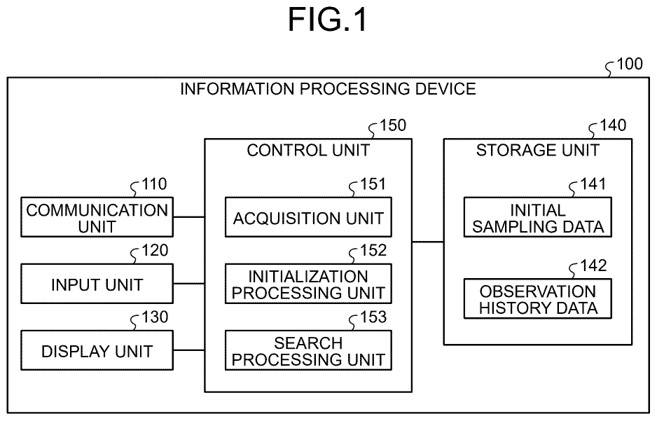

Next, the following describes a configuration example of the information processing device 100 that performs the processing described above. FIG. 1 is a functional block diagram illustrating a configuration of the information processing device according to the present embodiment. As illustrated in FIG. 1, the information processing device 100 includes a communication unit 110, an input unit 120, a display unit 130, a storage unit 140, and a control unit 150.

The communication unit 110 performs data communication with an external device via a network. The communication unit 110 is implemented by a network interface card (NIC) and the like.

The input unit 120 is an input device for inputting various pieces of information to the information processing device 100. The input unit 120 corresponds to a keyboard, a mouse, a touch panel, and the like.

The display unit 130 is a display device that displays information output from the control unit 150. The display unit 130 corresponds to a liquid crystal display, an organic electroluminescence (EL) display, a touch panel, and the like.

The storage unit 140 includes initial sampling data 141 and observation history data 142. The storage unit 140 is a memory and the like.

The initial sampling data 141 is data of initial sampling distribution ro.

The observation history data 142 is data related to x₁, x₂, . . . , xₙ sampled in the initialization processing and γ₁, γ₂, . . . , γ_{N} estimated from such sampling. Every time the sampling processing described above is performed, data of x and y is successively added to the observation history data 142.

The control unit 150 includes an acquisition unit 151, an initialization processing unit 152, and a search processing unit 153. The control unit 150 is, for example, a central processing unit (CPU) and the like.

The acquisition unit 151 acquires the initial sampling data 141 from an external device and the like, and stores the acquired initial sampling data 141 in the storage unit 140

The initialization processing unit 152 samples x₁, x₂, . . . , x_{N} as parameters at N points based on the initial sampling data 141. Additionally, γ₁, γ₂, . . . , γ_{N} are observed based on a sampling result of the parameters at N points and Expression (4) described above. The initialization processing unit 152 registers sampled x₁, x₂, . . . , x_{N} and observed γ₁, γ₂, . . . , γ_{N} in the observation history data 142. Other description about the initialization processing unit 152 is the same as the description about the initialization processing.

The search processing unit 153 searches for the optimum parameter of the machine training model by repeatedly performing the estimation processing, the subgradient calculation processing, the projection calculation processing, and the sampling processing. The search processing unit 153 may output a search result to the display unit 130 to be displayed, or may notify the search result to an external device.

For example, the search processing unit 153 estimates an optimum parameter and a function that derives an observation result from a parameter based on the observation history data 142. The search processing unit 153 sets an optimization problem for minimizing the false identification probability of falsely identifying another parameter to be optimum based on the estimated function and the optimum parameter. The optimization problem is, for example, represented by Expression (21) and the like. The search processing unit 153 searches for the parameter as an optimal solution to the machine training model by applying the projection subgradient method to the optimization problem.

For example, the search processing unit 153 specifies a set of the optimum parameter and another parameter with which the false identification probability is increased, obtains a new probability measure Πₜ₊₁ with which the specified set is identified more easily, and samples a parameter of the machine training model from the new probability measure Πₜ₊₁.

Specific processing by the search processing unit 153 is the same as the processing described in the estimation processing, the subgradient calculation processing, the projection calculation processing, and the sampling processing.

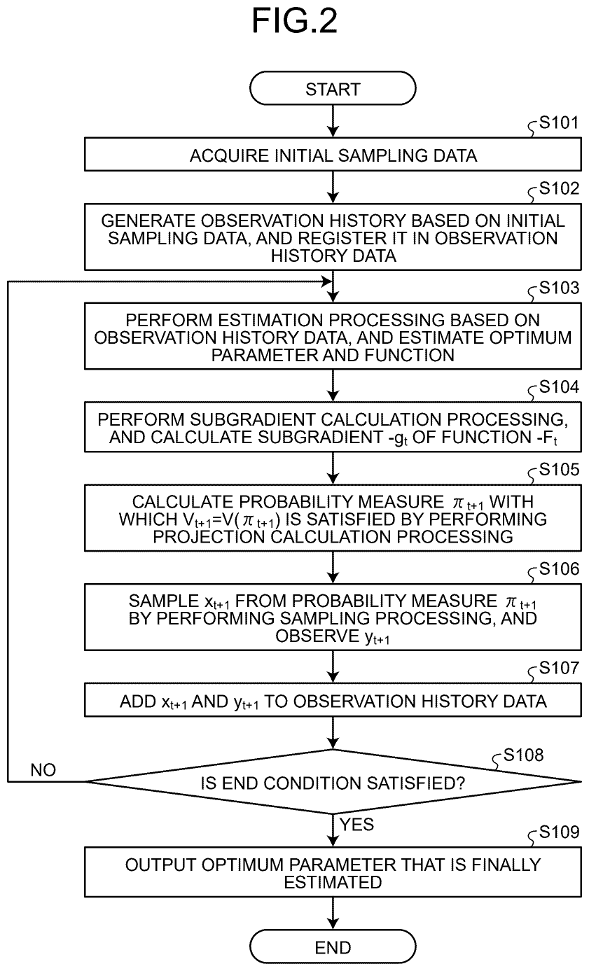

Next, the following describes an example of a processing procedure of the information processing device 100 according to the first embodiment. FIG. 2 is a flowchart illustrating a processing procedure of the information processing device according to the present embodiment.

As illustrated in FIG. 2, the acquisition unit 151 of the information processing device 100 acquires the initial sampling data 141 (Step S101). The initialization processing unit 152 of the information processing device 100 generates an observation history based on the initial sampling data 141, and registers it in the observation history data 142 (Step S102).

The search processing unit 153 of the information processing device 100 performs the estimation processing based on the observation history data 142, and estimates the optimum parameter x\hat{ }ₜ and the function f\hat{ }ₜ(x) (Step S103). The search processing unit 153 performs the subgradient calculation processing, and calculates the subgradient −gₜ of the function −Fₜ (Step S104).

The search processing unit 153 calculates the probability measure Πₜ₊₁ with which Vₜ₊₁=V (Πₜ₊₁) is satisfied by performing the projection calculation processing (Step S105). The search processing unit 153 samples xₜ₊₁ from Πₜ₊₁ by performing the sampling processing, and observes γₜ₊₁ (Step S106). The search processing unit 153 adds xₜ₊₁ and γₜ₊₁ to the observation history data 142 (Step S107).

If the end condition is not satisfied (No at Step S108), the search processing unit 153 makes the processing procedure transition to Step S103. On the other hand, if the end condition is satisfied (Yes at Step S108), the search processing unit 153 outputs the optimum parameter that is finally estimated (Step S109).

Next, the following describes an effect of the information processing device 100 according to the present embodiment. The information processing device 100 estimates an optimum parameter and a function that derives an observation result from a parameter based on the observation history data 142. The information processing device 100 sets an optimization problem for minimizing the false identification probability of falsely identifying another parameter to be optimum based on the estimated function and the optimum parameter. The optimization problem is, for example, represented by Expression (21) and the like. The information processing device 100 searches for a parameter as an optimal solution to the machine training model by applying the projection subgradient method to the optimization problem. Due to this, the optimum parameter of the machine training model can be searched for.

The information processing device 100 specifies a set of the optimum parameter and another parameter with which the false identification probability is increased based on the optimization problem, obtains a new probability measure with which the specified set is identified more easily, and samples a parameter of the machine training model from the new probability measure. Due to this, the false identification probability can be entirely lowered regardless of whether it is difficult to identify the optimum parameter and another parameter, and the optimum parameter of the machine training model can be searched for.

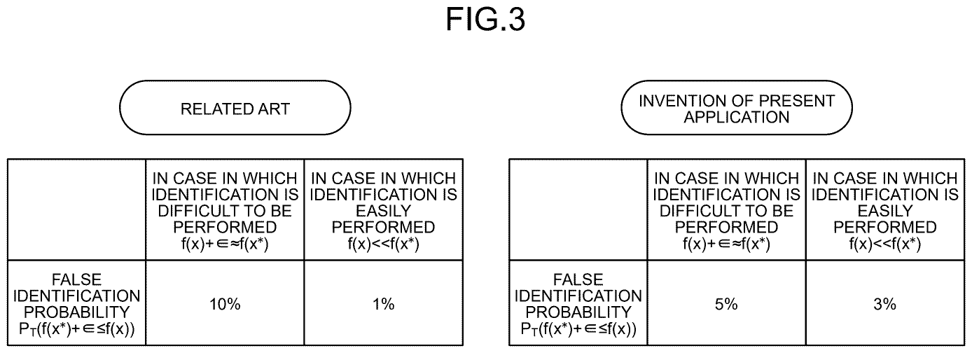

Herein, a false identification probability in the related art is compared with the false identification probability of the information processing device 100 according to the invention of the present application. FIG. 3 is a diagram illustrating an example of the false identification probability. As illustrated in FIG. 3, in the related art, false identification probabilities are not balanced such that the false identification probability is “10%” in a case in which it is difficult to identify the optimum parameter and the other parameter, and the false identification probability is “1%” in a case in which it is easy to identify the optimum parameter and the other parameter. For example, in the related art, the false identification probability is increased in a case in which identification is difficult to be performed.

On the other hand, in the invention of the present application, the false identification probabilities are balanced such that the false identification probability is “5%” in a case in which it is difficult to identify the optimum parameter and the other parameter, and the false identification probability is “3%” in a case in which it is easy to identify the optimum parameter and the other parameter. Thus, in the invention of the present application, the false identification probability can be entirely lowered regardless of whether identification is difficult to be performed.

Next, the following sequentially describes an example of a hardware configuration of a computer that implements the same function as that of the information processing device 100 described in the above embodiment.

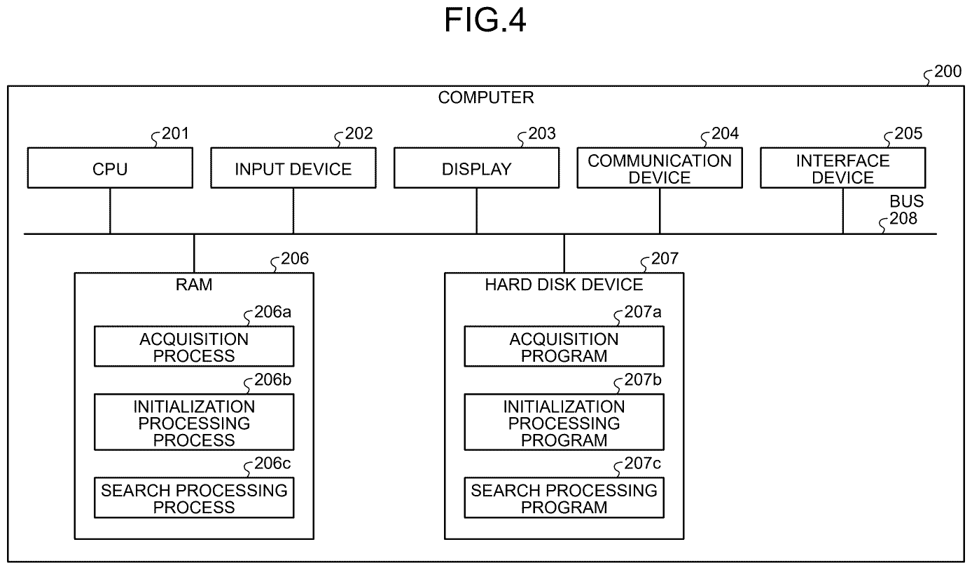

FIG. 4 is a diagram illustrating an example of the hardware configuration of the computer that implements the same function as that of the information processing device according to the embodiment. As illustrated in FIG. 4, a computer 200 includes a CPU 201 that performs various kinds of arithmetic processing, an input device 202 that receives a data input from a user, and a display 203. The computer 200 also includes a communication device 204 that exchanges data with an external device and the like via a wired or wireless network, and an interface device 205. The interface device 205 may be connected to a microphone, a speaker, or the like. The computer 200 further includes a RAM 206 that temporarily stores therein various kinds of information, and a hard disk device 207. Each of the devices 201 to 207 is connected to a bus 208.

The hard disk device 207 includes an acquisition program 207a, an initialization processing program 207b, and a search processing program 207c. The CPU 201 reads out each of the computer programs 207a to 207c to be loaded onto the RAM 206.

The acquisition program 207a functions as an acquisition process 206a. The initialization processing program 207b functions as an initialization processing process 206b. The search processing program 207c functions as a search processing process 206c.

Processing of the acquisition process 206a corresponds to processing of the acquisition unit 151. Processing of the initialization processing process 206b corresponds to processing of the initialization processing unit 152. Processing of the search processing process 206c corresponds to processing of the search processing unit 153.

Each of the computer programs 207a to 207c is not necessarily stored in the hard disk device 207 from the beginning. For example, each computer program may be stored in a “portable physical medium” such as a flexible disk (FD), a CD-ROM, a DVD, a magneto-optical disc, or an IC card to be inserted into the computer 200. The computer 200 may then read out and execute each of the computer programs 207a to 207e.

An optimum parameter of a machine training model can be searched for.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising:
a processor configured to:
estimate, based on observation history data including a parameter of a machine training model that is sampled based on a probability measure on a parameter space and an observation result that is estimated in a case of setting the parameter to the machine training model, an optimum parameter and a function of the parameter that derives the observation result;
set an optimization problem for minimizing a false identification probability of falsely identifying, as an optimal solution, another parameter other than the optimum parameter on the parameter space based on the estimated function and the optimum parameter; and
search for a parameter to be an optimal solution to the machine training model by applying a projection subgradient method to the optimization problem.

2. The information processing device according to claim 1, wherein the processor is further configured to:
specify a pair of the optimum parameter and the another parameter with which the false identification probability is increased based on the optimization problem, and obtain a new probability measure with which the set is identified more easily, and
perform processing of sampling a parameter of the machine training model from the new probability measure.

3. The information processing device according to claim 2, wherein the optimization problem is a problem for obtaining a probability measure that maximizes a value of the following Expression (1), where, as terms included in Expression (1), f is the function to be estimated, x* is the optimum parameter to be estimated, x′ is the another parameter, ε is an error, and V is a covariance matrix of the probability measure.
$$F ( V ) = {inf}_{{x}^{′} \neq {x}^{*}} \frac{{( ϵ + f ( {x}^{*} ) - f ( {x}^{′} ) )}^{2}}{{\vert {x}^{*} - {x}^{′} \vert}_{{V}^{- 1}}^{2}} \qquad ( 1 )$$

4. The information processing device according to claim 3, wherein the processor is further configured to:
calculate a subgradient of the covariance matrix at a certain time of trial based on the optimization problem,
calculate the covariance matrix at a next time of trial by performing approximate projection based on the subgradient, and
calculate the new probability measure based on the covariance matrix at the next time of trial.

5. A searching method comprising:
estimating, based on observation history data including a parameter of a machine training model that is sampled based on a probability measure on a parameter space and an observation result that is estimated in a case of setting the parameter to the machine training model, an optimum parameter and a function of the parameter that derives the observation result;
setting an optimization problem for minimizing a false identification probability of falsely identifying, as an optimal solution, another parameter other than the optimum parameter on the parameter space based on the estimated function and the optimum parameter; and
searching for a parameter to be an optimal solution to the machine training model by applying a projection subgradient method to the optimization problem, by a processor.
